(19) United States
(12) Patent Application Publication
(10) Pub. No.: US 2006/0082635 A1
(43) Pub. Date: Apr. 20, 2006

(54) Light scanning unit and image forming apparatus employing the same

(76) Inventors: Woo-kyu Kim, Suwon-si (KR); Hyun-surk Kim, Suwon-si (KR); Sang-hoon Lee, Seongnam-si (KR)

Correspondence Address: STANZIONE & KIM, LLP, 919 18TH STREET, N.W., SUITE 440, WASHINGTON, DC, 20006, US

(21) Appl. No.: 11/248,275

(22) Filed: Oct. 13, 2005

(30) Foreign Application Priority Data
Oct. 18, 2004 (KR) 2004-83234

(51) Int. Cl. B41J 2/415

(52) U.S. Cl. 347/125

(57) ABSTRACT

A light scanning unit, which can prevent contamination using a photocatalytic layer, and an image forming apparatus employing the same. The light scanning unit includes a light source to switch on and off to generate at least one beam that corresponds to an image signal, a beam deflector to deflect and scan the at least one beam emitted by the light source, a housing containing the light source and the beam deflector, a transparent cover installed on the housing to protect internal elements within the housing and to transmit the at least one beam deflected and scanned by the beam deflector, and a photocatalytic layer formed on at least one surface of the transparent cover to be activated by an incident beam having a predetermined wavelength to decompose organic materials thereon.

### CROSS-REFERENCE TO RELATED APPLICATIONS

This application claims priority from Korean Patent Application No. 2004-83234, filed on Oct. 18, 2004, in the Korean Intellectual Property Office, the disclosure of which is incorporated herein in its entirety by reference.

### BACKGROUND OF THE INVENTION

1. Field of the Invention

The present general inventive concept relates to a light scanning unit to scan light emitted from a light source onto a surface and an image forming apparatus employing the same, and more particularly, to a light scanning unit constructed to prevent contamination using a photocatalyst and an image forming apparatus employing the same.

2. Description of the Related Art

In general, a light scanning unit is employed in a laser printer, a digital copier, a barcode reader, a facsimile, etc., and forms a latent image on an exposed object by main scanning using a beam deflector and by sub-scanning using a rotation of the exposed object.

Referring to FIGS. 1 and 2, a conventional light scanning unit includes a light source 1 for generating and emitting a beam, a beam deflector 5 for deflecting the beam emitted by the light source 1 to be scanned on an exposed object 15, and an f-θ lens 7 for correcting an error contained in the beam deflected by the beam deflector 5. Further, a collimating lens 2 for focusing the beam emitted by the light source 1 and a cylindrical lens 3 for shaping the beam are disposed in an optical path between the light source 1 and the beam deflector 5.

The beam deflector 5 includes a driving source 5a and a polygonal mirror 5b rotated by the driving source 5a. The polygonal mirror 5b has a plurality of reflective surfaces. Accordingly, a reflection direction of the beam emitted by the light source 1 and formed on each of the reflective surfaces changes as the polygonal mirror 5b rotates. When the polygonal mirror 5b rotates, the beam incident on the polygonal mirror 5b is scanned in a main scanning direction.

However, it is necessary to prevent impurities from contaminating internal optical elements of the conventional light scanning unit including the light source 1, the beam deflector 5, and the f-θ lens 7, since contamination significantly degrades scanning performance.

Therefore, the internal optical elements of the conventional light scanning unit reside in a housing 10. Here, the housing 10 includes a cover glass 12 through which the beam deflected by the beam deflector 5 is transmitted to the exposed object 15. As such, the internal optical elements are enclosed and protected from external impurities by the housing 10 and the cover glass 12, thereby preventing the contamination of the internal optical elements by the external impurities.

However, the cover glass 12 through which the beam is transmitted may become contaminated with the impurities. FIG. 3 is a graph illustrating transmittance versus a wavenumber of a cover glass sealing adhesive and impurities on the cover glass 12, to illustrate a degree of contamination and causes of the contamination of the cover glass 12. Referring to FIG. 3, a pattern of the transmittance versus the wavenumber is similar between the cover glass sealing adhesive and the impurities on the cover glass 12. It is evident from the graph of FIG. 3 that a major cause of the contamination of the cover glass 12 is the cover glass sealing adhesive. Further, in the transmittance pattern, the transmittance is reduced to 80% or less when the wavenumber is less than approximately 1700, and ranges from approximately 2700 to 3600.

Accordingly, when the internal optical elements of the conventional light scanning unit are protected by the housing 10 and the cover glass 12, the quality of the scanned beam deteriorates due to the contamination of the cover glass 12.

### SUMMARY OF THE INVENTION

The present general inventive concept provides a light scanning unit to prevent contamination of a surface of a transparent cover by decomposing contaminants using a photocatalyst, and an image forming apparatus employing the same.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a light scanning unit, comprising a light source to switch on or off to generate at least one beam that corresponds to an image signal, a beam deflector to deflect and scan the at least one beam emitted by the light source, a housing containing the light source and the beam deflector, a transparent cover installed on the housing to protect internal elements within the housing and to transmit the at least one beam deflected and scanned by the beam deflector, and a photocatalytic layer formed on at least one surface of the transparent cover to be activated by an incident beam having a predetermined wavelength to decompose organic materials thereon.

The foregoing and/or other aspects of the present general inventive concept are also achieved by providing a light scanning unit usable with an image forming apparatus. The light scanning unit includes a housing having a transparent cover part through which light is transmittable, at least one light source disposed in the housing to emit a light beam, one or more optical components disposed in the housing to process the emitted light beam, and at least one photocatalytic layer disposed on the transparent cover part to be activated by a light beam having a predetermined wavelength to break down organic materials on a surface thereof.

The foregoing and/or other aspects of the present general inventive are also achieved by providing a light scanning unit usable with an image forming apparatus. The light scanning unit includes a housing to contain internal components of the light scanning unit, and a glass cover disposed in an opening in the housing and having a photocatalytic layer disposed on at least one surface to pass light of a first wavelength emitted from within the housing to an exposed object outside the housing, and to react with light of a second wavelength.

The foregoing and/or other aspects of the present general inventive concept are also achieved by providing a method performed by a light scanning unit including a housing having a transparent cover part through which light is transmittable, at least one light source to emit at least one light beam, and at least one photocatalytic layer disposed on the transparent cover part. The method includes emitting a first light beam having a first wavelength through the transparent cover part to scan an exposed object disposed outside the housing, and emitting a second light beam having a second wavelength to the at least one photocatalytic layer to activate the at least one photocatalytic layer to decompose any organic materials disposed on a surface thereof.

The foregoing and/or other aspects of the present general inventive concept are also achieved by providing an image forming apparatus, comprising a developing unit, a light scanning unit to emit a beam to the developing unit to form an electrostatic latent image therein, a transfer unit that corresponds to a position of the developing unit and to transfer an image formed in the developing unit to a print medium, and a fixing unit to fix the image transferred to the print medium on the print medium. The light scanning unit includes a light source to emit a beam having a first wavelength, a beam deflector to be rotated to deflect and scan an incident beam, a housing containing the light source and the beam deflector, a transparent cover installed on the housing to protect internal elements within the housing and to transmit the incident beam, and a photocatalytic layer formed on at least one surface of the transparent cover to be activated by a beam having a predetermined wavelength to decompose organic materials thereon.

The foregoing and/or other aspects of the present general inventive concept are also achieved by providing an image forming apparatus, including a photosensitive body, and a light scanning unit to scan a light beam to form an electrostatic latent image on the photosensitive body. The light scanning unit includes a housing having a transparent window through which the scanned light beam is transmitted, and a photocatalytic layer disposed on one or more surfaces of the transparent window to be activated by one or more predetermined wavelengths to break down impurities on the one or more surfaces of the transparent window to increase a transmittance of the scanned light beam through the transparent window.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a perspective view illustrating a conventional light scanning unit;

FIG. 2 is a schematic cross-sectional view illustrating the conventional light scanning unit of FIG. 1;

FIG. 3 is a graph illustrating a wavenumber versus a transmittance of a cover glass sealing adhesive and impurities on a cover glass of the conventional light scanning unit of FIG. 1;

FIG. 4 is a schematic cross-sectional view illustrating an optical arrangement of a light scanning unit according to an embodiment of the present general inventive concept;

FIG. 5 is a schematic cross-sectional view illustrating a transparent cover of the light scanning unit of FIG. 4;

FIG. 6 is a schematic view illustrating a principle of photocatalysis; and

FIG. 7 is a schematic cross-sectional view illustrating an image forming apparatus according to an embodiment of the present general inventive concept.

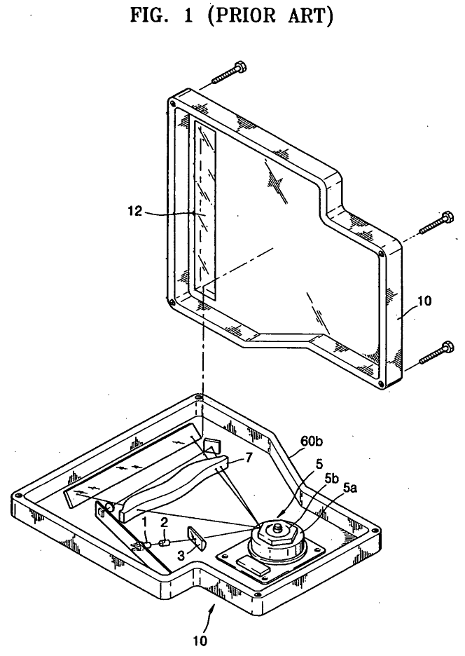

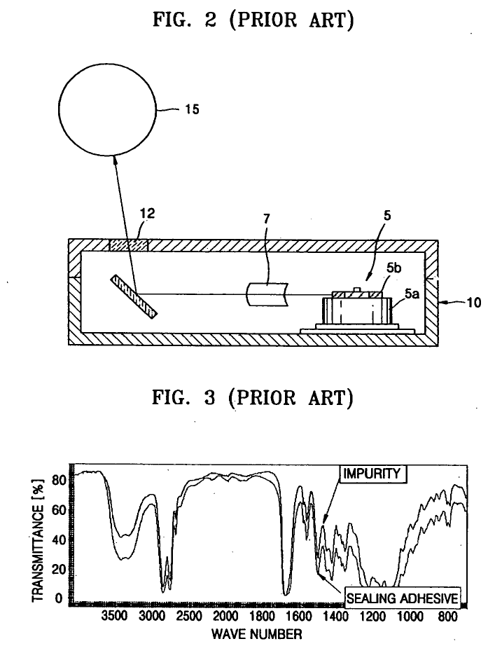

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

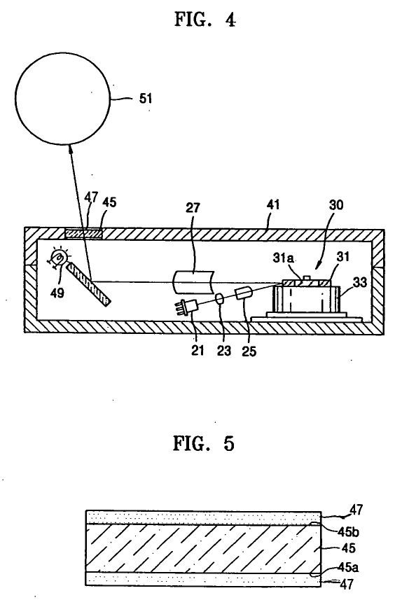

Referring to FIGS. 4 and 5, a light scanning unit according to an embodiment of the present general inventive concept includes a light source 21 to generate and emit a light beam, a beam deflector 30 to deflect the beam emitted by the light source 21 such that the deflected beam is scanned on an exposed object 51, a housing 41 containing optical elements including the light source 21 and the beam deflector 30, a transparent cover 45 installed on the housing 41, and a photocatalytic layer 47 formed on at least one surface of the transparent cover 45. The transparent cover 45 may comprise glass. Alternatively, other transparent materials (e.g., clear plastic) may be used to form the transparent cover 45.

The light source 21 is turned on or off to generate and emit at least one beam that corresponds to an image signal. That is, the light source 21 may comprise a semiconductor laser or a light emitting diode (LED) and may emit a beam having a first wavelength.

The beam deflector 30 includes a polygonal mirror 31 having a plurality of reflective surfaces 31a and a driving source 33 to rotate the polygonal mirror 31. A direction in which the beam emitted by the light source 21 is deflected by each of the reflective surfaces 31a changes as the polygonal mirror 31 rotates. Accordingly, the beam incident on the polygonal mirror 31 is scanned. An f-θ lens 27 may be disposed in an optical path between the beam deflector 30 and the transparent cover 45 such that the beam deflected by the beam deflector 30 can be scanned at a constant speed and at a constant angle. The f-θ lens 27 corrects the beam deflected by the beam deflector 30 at different magnifications for a main scanning direction and a sub-scanning direction such that the corrected beam can be focused onto the exposed object 51. The sub-scanning direction refers to a direction in which the exposed object 51 rotates, and the main scanning direction refers to an axial direction of the exposed object 51 (i.e., the direction in which the beam is deflected by the polygonal mirror 31).

The light scanning unit may further include a collimating lens 23 and at least one cylindrical lens 25 disposed in an optical path between the light source 21 and the beam deflector 30. The collimating lens 23 collimates the beam emitted by the light source 21 into a parallel or convergent beam. The cylindrical lens 25 focuses an incident beam differently on the polygonal mirror 31 in the main scanning direction and the sub-scanning direction.

The transparent cover 45 is disposed on the housing 41 to protect internal elements within the housing 41, and transmits the beam deflected and scanned by the beam deflector 30 to the exposed object 51.

As illustrated in FIGS. 4 and 5, the photocatalytic layer 47 is formed on a beam entrance surface 45a and/or on a beam exit surface 45b of the transparent cover 45. The photocatalytic layer 47 is activated by an incident beam having a predetermined activation wavelength to decompose organic materials.

The photocatalytic layer 47 may be made of a material that is activated by a laser beam having a first wavelength (e.g., a wavelength of 780 nm) emitted by the light source 21 to generate a hydroxyl radical (—OH). That is, the predetermined activation wavelength may be designed to be equal to the first wavelength emitted by the light source 21. The material of the photocatalytic layer 47 may, for example, include a semiconductor metal oxide, such as TiO₂, WO₂, or SrTiO₂, and a sulfur compound, such as CdS or MOS₂.

The material of the photocatalytic layer 47 may alternatively be made of other materials that are activated by a beam having a second wavelength (e.g., a wavelength of 300 to 400 nm), which may correspond to the predetermined activation wavelength. In this case, an activating light source 49 may be further disposed near the transparent cover 45 to emit the beam having the second wavelength. The activating light source 49 may be separate from the light source 21 and may emit a beam at times that are different from when the light scanning unit performs the beam scanning operation such that a scan line is not affected by the beam emitted by the activating light source 49.

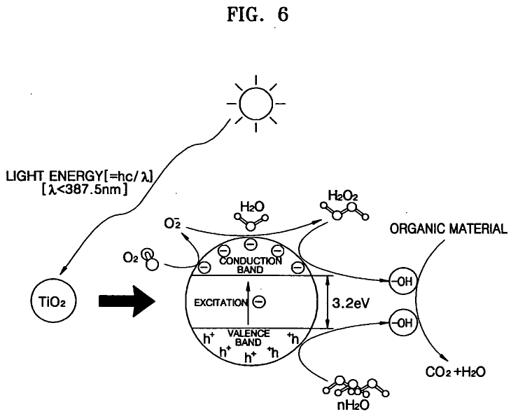

FIG. 6 illustrates a process of removing contaminants when the photocatalytic layer 47 is made of a semiconductor metal oxide TiO₂. Referring to FIG. 6, a beam having a predetermined wavelength (e.g., a wavelength that is shorter than 387.5 nm) excites electrons from a valence band to a conduction band. That is, the electrons are created in the conduction band and electron holes are created in the valence band. The electrons and the electron holes form oxygen (O₂) in the air, water (H₂O), and a hydroxyl radical (—OH). The hydroxyl radical (—OH) is a powerful oxidizer and decomposes a carbon-containing organic material into CO₂ and H₂O.

Hence, even though the transparent cover 45 on which the photocatalytic layer 47 is formed is contaminated with organic materials, the organic materials can be decomposed and removed by emitting the light of the predetermined activation wavelength on the photocatalytic layer 47 and forming a hydroxyl radical (—OH). Thus, the activating light source 49 can decompose the organic material on the photocatalytic layer 47 of the transparent cover 45.

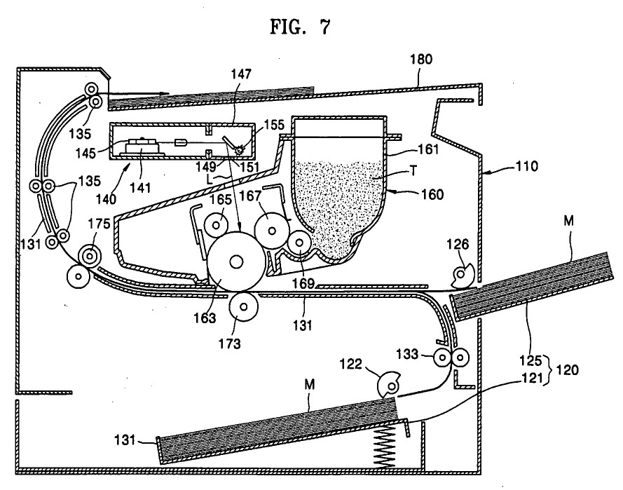

Referring to FIG. 7, an image forming apparatus according to an embodiment of the present general inventive concept includes a cabinet 110, a developing unit 160 mounted in the cabinet 110, a light scanning unit 140 to form an electrostatic latent image on a photosensitive medium 163, a transfer unit 173 to transfer the image formed on the photosensitive medium 163 to a print medium M, and a fixing unit 175 to fix the transferred image on the print medium M.

The cabinet 110 contains most of the components of the image forming apparatus. A discharging unit 180 to discharge the print medium M having the image fixed thereon is disposed outside the cabinet 110. Further, a feeding unit 120 in which a stack of print medium M is arranged is detachably disposed in the cabinet 110. The print medium M is fed by the feeding unit 120 and is transferred to the developing unit 160 via a transport path 131.

The feeding unit 120 includes a first feeder 121 to automatically feed the print medium M, and a second feeder 125 to manually feed the print medium M. The first feeder 121 is disposed inside the cabinet 110 and feeds the stacked print medium M to the transport path 131 due to rotation of a first feeding roller 122. The second feeder 125 is installed outside the cabinet 110 and feeds the print medium M to the transport path 131 due to a rotation of a second feeding roller 126.

The transport path 131 is formed inside the cabinet 110, and transports the print medium M fed by the feeding unit 120. The transport path 131 includes a plurality of transport rollers 133 and 135. The transport path 131 includes a feeding path branched into two parts to separately supply the print medium M from the first and second feeders 121 and 125, an image forming path, and a discharging path integrated into a single path.

The developing unit 160 includes a toner container 161 in which toner T of a predetermined color is contained, and an image forming unit to receive the toner T from the toner container 161 and to form the image.

The image forming unit includes the photosensitive medium 163 to react to a beam L scanned by the light scanning unit 140 such that the electrostatic latent image is formed thereon, a charger 165 to charge the photosensitive medium 163 to a predetermined potential, a developing roller 167 facing the photosensitive medium 163 to develop a region of the photosensitive medium 163 where the electrostatic latent image is formed with the toner T, and a supply roller 169 to supply the toner T to the developing roller 167.

The light scanning unit 140 scans the beam L onto the photosensitive medium 163 to form the electrostatic latent image thereon. The light scanning unit 140 includes the light source 21 (see FIG. 4), a beam deflector comprising a driving source 141 and a polygonal mirror 145, a housing 147 to contain the light source 21 (see FIG. 4) and the beam deflector, a transparent cover 149 to protect internal elements of the light scanning unit 140 within the housing 147 and to transmit an incident beam, and a photocatalytic layer 151 formed on at least one surface of the transparent cover 149 to be activated by an incident beam having a predetermined activation wavelength to decompose any organic materials thereon. The photocatalytic layer 151 can prevent contamination by decomposing impurities on a surface thereof. The transparent cover 149 may comprise glass. Alternatively, other transparent materials (e.g., clear plastic) may be used to form the transparent cover 149. Further, when the photocatalytic layer 151 is activated by a beam having a wavelength, which is different from a beam emitted by the light source 21, the light scanning unit 140 further includes an activating light source 155 disposed near the transparent cover 149 to emit the beam having the predetermined activation wavelength to decompose the organic materials. Since the structure and operation of the light scanning unit 140 are substantially identical to the structure and operation of the light scanning unit illustrated in FIG. 4, a detailed explanation thereof will not be provided.

The transfer unit 173 faces the photosensitive medium 163 with the print medium M being transported via the transport path 131 interposed therebetween. The transfer unit 173 transfers the image formed on the photosensitive medium 163 to the print medium M. The image transferred to the print medium M by the transfer unit 173 is then fixed thereon by the fixing unit 175.

As described above, a light scanning unit and an image forming apparatus employing the same can actively remove impurities on a transparent cover by decomposing organic materials using a photocatalyst. Accordingly, image quality deterioration due to contamination of the transparent cover can be prevented.

Furthermore, impurities stuck on both inner and outer surfaces of the transparent cover during assembly of the light scanning unit can be actively removed by forming the photocatalytic layer on both inner and outer surfaces of the transparent cover.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A light scanning unit, comprising:
a light source to switch on and off to generate at least one beam that corresponds to an image signal;
a beam deflector to deflect and scan the at least one beam emitted by the light source;
a housing containing the light source and the beam deflector;
a transparent cover installed on the housing to protect internal elements within the housing and to transmit the at least one beam that is deflected and scanned by the beam deflector; and
a photocatalytic layer formed on at least one surface of the transparent cover to be activated by an incident beam having a predetermined wavelength to decompose organic materials thereon.

2. The light scanning unit of claim 1, wherein the photocatalytic layer comprises a material that is activated by the incident beam having the predetermined wavelength and generates a hydroxyl radical (—OH).

3. The light scanning unit of claim 2, wherein the photocatalytic layer comprises a metal oxide.

4. The light scanning unit of claim 3, wherein the photocatalytic layer comprises a material selected from the group consisting of TiO and WO₂.

5. The light scanning unit of claim 2, wherein the photocatalytic layer comprises a sulfur compound.

6. The light scanning unit of claim 5, wherein the photocatalytic layer comprises a material selected from the group consisting of CdS, SrTiO₂, and MoS₂.

7. The light scanning unit of claim 1, wherein the photocatalytic layer comprises a material that is activated by a beam having a first wavelength emitted from the light source.

8. The light scanning unit of claim 1, further comprising:
an activating light source to emit the incident beam having the predetermined wavelength to the photocatalytic layer, and the predetermined wavelength is different from a first wavelength emitted by the light source,
wherein the photocatalytic comprises a material that is activated by the incident beam having the predetermined wavelength emitted by the activating light source.

9. A light scanning unit usable with an image forming apparatus, the light scanning unit comprising:
a housing having a transparent cover part through which light is transmittable;
at least one light source disposed in the housing to emit a light beam;
one or more optical components disposed in the housing to process the emitted light beam; and
at least one photocatalytic layer disposed on the transparent cover part to be activated by a light beam having a predetermined wavelength to break down organic materials on a surface thereof.

10. The light scanning unit of claim 9, wherein the at least one light source comprises:
a first light source to emit a first light beam having a first wavelength to the one or more optical components to scan an exposed objected disposed outside of the housing; and
a second light source disposed adjacent to the transparent cover part to emit a second light beam having a second wavelength to activate the at least one photocatalytic layer to break down the organic materials thereon.

11. The light scanning unit of claim 10, wherein the first light source operates at a first time, and the second light source operates at a second time that is different from the first time.

12. The light scanning unit of claim 9, wherein the predetermined wavelength activates the at least one photocatalytic layer to decompose the organic materials into water, oxygen, and a hydroxyl radical.

13. The light scanning unit of claim 9, wherein the at least one photocatalytic layer comprises:
a first photocatalytic layer disposed on an entrance surface of the transparent cover part to break down organic materials formed on an inside of the housing; and
a second photocatalytic layer disposed on an exit surface of the transparent cover part to break down organic materials formed on an outside of the housing.

14. The light scanning unit of claim 9, wherein the one or more optical components comprise:
a beam deflector having a plurality of reflective surfaces to scan the emitted light beam through the transparent cover part on an object to be exposed; and
one or more of a planar reflector, an f-θ lens, a collimating lens, and a cylindrical lens disposed in an optical path of the scanned light beam.

15. The light scanning unit of claim 9, wherein the predetermined wavelength is less than 387.5 nanometers.

16. The light scanning unit of claim 9, wherein the at least one photocatalytic layer comprises a semiconductor metal oxide to pass a first group of wavelengths and to be activated by a second group of wavelengths including the predetermined wavelength.

17. The light scanning unit of claim 16, wherein the semiconductor metal oxide comprises one of TiO₂, WO₂, and SrTiO₂, and a sulfur compound comprising one of CdS and MoS₂.

18. The light scanning unit of claim 9, wherein the at least one photocatalytic layer transforms a carbon containing organic material into CO₂ and H₂O.

19. The light scanning unit of claim 9, wherein the predetermined wavelength excites electrons from a valence band of the at least one photocatalytic layer to a conduction band of the at least one photocatalytic layer.

20. The light scanning unit of claim 19, wherein the electrons are created in the conduction band of the at least one photocatalytic layer and electron holes are created in the valence band of the at least one photocatalytic layer, and the electrons and the electron holes form oxygen, water, and a hydroxyl radical.

21. The light scanning unit of claim 9, wherein the at least one light source comprises a scanning light source to emit a beam of the predetermined wavelength to scan an exposed object disposed outside the housing while activating the at least one photocatalytic layer.

22. The light scanning unit of claim 9, wherein the emitted light beam has a wavelength that is not equal to the predetermined wavelength.

23. A light scanning unit usable with an image forming apparatus, the light scanning unit comprising:
a housing to contain internal components of the light scanning unit; and
a glass cover disposed in an opening in the housing and having a photocatalytic layer disposed on at least one surface to pass light of a first wavelength emitted from within the housing to an exposed object outside the housing, and to react with light of a second wavelength.

24. The light scanning unit of claim 23, wherein the light of the second wavelength reacts with the photocatalytic layer to produce a powerful oxidizer to decompose any impurities on the glass cover.

25. A method performed by a light scanning unit including a housing having a transparent cover part through which light is transmittable, at least one light source to emit at least one light beam, and at least one photocatalytic layer disposed on the transparent cover part, the method comprising:
emitting a first light beam having a first wavelength through the transparent cover part to scan an exposed object disposed outside the housing; and
emitting a second light beam having a second wavelength to the at least one photocatalytic layer to activate the at least one photocatalytic layer to decompose any organic materials disposed on a surface thereof.

26. An image forming apparatus, comprising:
a developing unit;
a light scanning unit to emit a beam to the developing unit to form an electrostatic latent image therein, the light scanning unit including:
a light source to emit a beam having a first wavelength,
a beam deflector to be rotated to deflect and scan an incident beam,
a housing containing the light source and the beam deflector,
a transparent cover installed on the housing to protect internal elements within the housing and to transmit the incident beam deflected and scanned by the beam deflector, and
a photocatalytic layer formed on at least one surface of the transparent cover to be activated by a beam having a predetermined wavelength to decompose organic materials thereon,
a transfer unit that corresponds to a position of the developing unit to transfer an image formed in the developing unit to a print medium; and
a fixing unit to fix the image transferred to the print medium on the print medium.

27. The image forming apparatus of claim 26, wherein the photocatalytic layer comprises a material that is activated by the beam having the predetermined wavelength and generates a hydroxyl radical (—OH).

28. The image forming apparatus of claim 27, wherein the photocatalytic layer comprises a metal oxide.

29. The image forming apparatus of claim 28, wherein the photocatalytic layer comprises a material selected from the group consisting of TiO₂ and WO₂.

30. The image forming apparatus of claim 27, wherein the photocatalytic layer comprises a sulfur compound.

31. The image forming apparatus of claim 30, wherein the photocatalytic layer comprises a material selected from the group consisting of CdS, SrTiO₂, and MoS₂.

32. The image forming apparatus of claim 26, wherein the photocatalytic layer comprises a material that is activated by the beam having the first wavelength emitted by the light source.

33. The image forming apparatus of claim 26, further comprising:
an activating light source to emit a beam having a second wavelength, which corresponds to the predetermined wavelength to the photocatalytic layer,
wherein the photocatalytic layer comprises a material that is activated by the beam having the second wavelength emitted by the activating light source.

34. An image forming apparatus, comprising:
a photosensitive body; and
a light scanning unit to scan a light beam to form an electrostatic latent image on the photosensitive body, the light scanning unit comprising:
a housing having a transparent window through which the scanned light beam is transmitted, and
a photocatalytic layer disposed on one or more surfaces of the transparent window to be activated by one or more predetermined wavelengths to break down impurities on the one or more surfaces of the transparent window to increase a transmittance of the scanned light beam through the transparent window.

35. The image forming apparatus of claim 34, further comprising:
a developing unit to develop the electrostatic latent image formed on the photosensitive body;
a transfer unit to transfer the developed electrostatic latent image to a print medium;
a fixing unit to fix the transferred image to the print medium; and
one or more transport rollers to move the print medium into the image forming apparatus, to the transfer unit, to the fixing unit, and to move the print medium out of the image forming apparatus.
